(19) United States
(12) Patent Application Publication
(10) Pub. No.: US 2020/0302465 A1
(43) Pub. Date: Sep. 24, 2020

(54) SYSTEMS AND METHODS FOR TRACKING THE CREATION AND PROMULGATION OF CODES WITHIN A REFERRAL NETWORK

(71) Applicant: REFER SYSTEMS S.A. DE C.V., Queretaro (MX)

(72) Inventor: Jorge Eduardo VALADES, Querétaro (MX)

(21) Appl. No.: 16/827,530

(22) Filed: Mar. 23, 2020

Related U.S. Application Data
(60) Provisional application No. 62/822,737, filed on Mar. 22, 2019.
(60) Provisional application No. 62/854,092, filed on May 29, 2019.
(60) Provisional application No. 62/854,111, filed on May 29, 2019.
(60) Provisional application No. 62/854,112, filed on May 29, 2019.
(60) Provisional application No. 62/854,129, filed on May 29, 2019.
(60) Provisional application No. 62/854,133, filed on May 29, 2019.
(60) Provisional application No. 62/854,135, filed on May 29, 2019.

(51) Int. Cl. G06Q 30/02; G06Q 50/00; G06Q 20/36; G06Q 20/38

(52) U.S. Cl. CPC G06Q 30/0214; G06Q 30/0236; G06Q 50/01; G06K 7/1417; G06Q 20/36; G06Q 20/385; G06Q 30/0215

(57) ABSTRACT

A referral platform, comprising one or more storage devices; one or more servers configured to host the referral platform, the servers configured to: allow businesses to access the platform, register, and create promotions associated with a benefit related to a particular business and an amount the business will share for a referral related to the promotion; allow users to access the platform, select a promotion, create a personalized code, and share the personalized code with at least one contact, wherein the at least one contact can use the personalized code to obtain the benefit.

### CROSS-REFERENCE TO RELATED APPLICATIONS

This patent application claims the benefit of and claims priority under 35 U.S.C. § 119(e) to U.S. Provisional Patent Application Nos. 62/822,737, filed on Mar. 22, 2019, 62/854,092, filed on May 29, 2019, 62/854,111, filed on May 29, 2019, 62/854,112, filed on May 29, 2019, 62/854,129, filed on May 29, 2019, 62/854,133, filed on May 29, 2019, and 62/854,135, filed on May 29, 2019. The disclosures of each of which are incorporated herein by reference in their entireties.

### BACKGROUND

### 1. Technical Field

The embodiments described herein are related to a marketing platform, and more particularly to a platform that ensures real-time ROI metrics related to marketing and sales.

### 2. Related Art

Every business knows that referrals are an important part of marketing and business generation. If your customers like your product and trust in your quality, then they will often refer your business or products to their friends and family. Certain studies have shown that 56% of consumers' purchasing decisions are influenced by their friends and peers. For millennials, this percentage rises to 70%.

In more traditional marketing, business will try to get a celebrity to endorse their products and services via ad campaigns that incorporate ads on television, radio, in print, etc. But the advent of the social network has not made it imperative that brands get celebrities to endorse their products by wearing or using them, or mentioning them in their social media posts.

To some extent, these social media platforms have democratized the ability for anyone to become an influencer. Otherwise ordinary people can create an social media account or blog. If enough other users follow them, then they may shape purchasing decisions just like the more traditional celebrity endorser. In fact, 30% of consumers have indicated they are more likely to buy a product that is recommended by a non-celebrity blogger. Moreover, when pairing an influencer with a brand, it has been shown that the purchase intent can increase by 5.2×.

Often brands will approach individuals who have reached “influencer” status, in order to get the influencer to display or use their products in their posts. But while social media has democratized the referral ecosystem to some degree, most social network users will not reach influencer status and will never be compensated by brand owners for recommending or referring products or services. Moreover, it is very difficult for the brand owner to actually track Return On Investment (ROI).

### SUMMARY

Systems and methods for a marketing platform that democratizes the referral ecosystem and allows brand owners to get real-time ROI metrics are described herein.

A referral platform, comprising one or more storage devices; one or more servers configured to host the referral platform, the servers configured to: allow businesses to access the platform, register, and create promotions associated with a benefit related to a particular business and an amount the business will share for a referral related to the promotion; allow users to access the platform, select a promotion, create a personalized code, and share the personalized code with at least one contact, wherein the at least one contact can use the personalized code to obtain the benefit.

These and other features, aspects, and embodiments are described below in the section entitled “Detailed Description.”

### BRIEF DESCRIPTION OF THE DRAWINGS

Features, aspects, and embodiments are described in conjunction with the attached drawings, in which:

FIG. 1 is a diagram illustrating an example marketing platform 100 configured in accordance with one embodiment; and

FIGS. 2A and 2B illustrate the various players that can be involved and interact with platform of FIG. 1 in accordance with one example embodiment;

FIGS. 3A and 3B illustrate how various players within the platform of FIG. 1 benefit in relation to various promotions;

FIGS. 4A and 4B are diagrams illustrating how an ambassador operates with respect to the platform illustrated in FIG. 1;

FIG. 5 is a screen shot illustrating the listing of promotions within the platform illustrated in FIG. 1 by category;

FIG. 6 is a diagram illustrating how micro-influencers can incorporate the QR codes into their social media posts in the platform illustrated in FIG. 1;

FIG. 7 is a screen shot that illustrates how codes can be included in, e.g., Youtube or other video posts in the platform illustrated in FIG. 1;

FIG. 8 is a screen shot that illustrates an example of how the codes can be used in a gaming environment in the platform illustrated in FIG. 1;

FIG. 9 is a screen shot that illustrates how the codes can be used in, e.g, an Instagram post in the platform illustrated in FIG. 1;

FIG. 10 is a diagram of how the codes can be used offline in the platform illustrated in FIG. 1;

FIGS. 11A and 11B are diagrams illustrating how ecommerce sites can access API's in order to also provide promotions and codes in the platform illustrated in FIG. 1;

FIG. 12 is a screen shot of dashboard businesses on the platform illustrated in FIG. 1 can use to see their promotions, their wallet, i.e., promotion balances, and to see who their top influencers are;

FIG. 13 illustrates how the codes can also be used for a type of rewards program in the platform illustrated in FIG. 1;

FIG. 14 is a block diagram illustrating an example wired or wireless system that can be used in connection with various embodiments described herein; and

FIGS. 15A-I are screenshots illustrating further listing, selection and sharing of promotions within the platform illustrated in FIG. 1.

### DETAILED DESCRIPTION

Certain embodiments are described herein in reference to various system components, devices, actors, etc. It will be understood that embodiments are presented by way of example and are not necessarily intended to illustrate all possible embodiments or implementations. It will also be understood that aspects and features of one embodiment can be combined with one or more aspects or features of one or more other embodiments. It will also be understood that not all necessary system components, devices, actors, etc., are presented with respect to each embodiment, but rather that necessary to sufficiently convey the various features, aspects, functions, etc., of the various embodiments are disclosed.

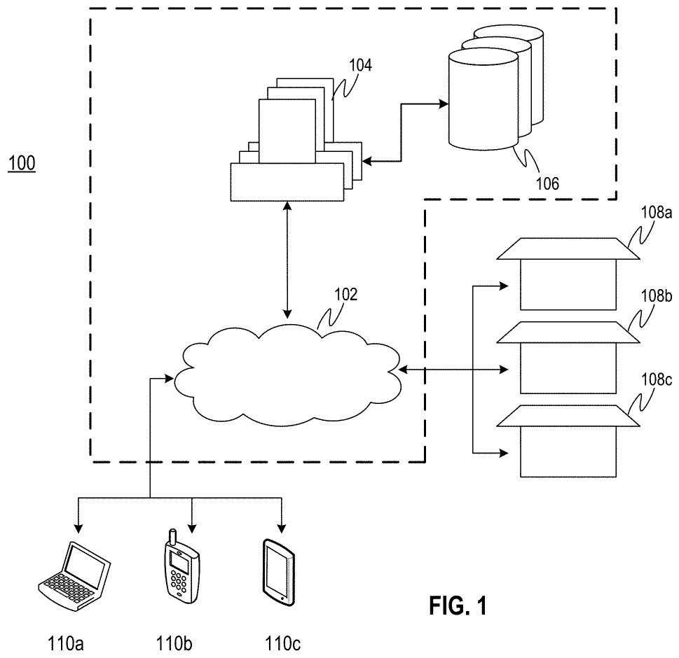

FIG. 1 is a diagram illustrating an example marketing platform 100 configured in accordance with one embodiment. As illustrated in FIG. 1, the platform 100, which can comprise various applications, user interfaces, routines, algorithms, etc., can be hosted by one or more servers 104 coupled with one or more storage devices 106. A plurality of users can access the platform 100 via various, illustrated here as devices 110a-c, including smartphones, tablets, personal computers, laptops, etc., via network 102. Thus, a user can download an application onto their device 110 or use a browser to access platform 100.

It will be understood that network 102, servers 104, and storage devices 106, along with the applications, user interfaces, routines, algorithms, etc., can together form a cloud based platform 100 for the systems and methods described herein.

Various businesses 108a-c can also access the platform 100 in order to create promotions, track ROI metrics and more as described below. It will be understood that the business personnel can access the platform 100 via devices similar to devices 110a-c as described above.

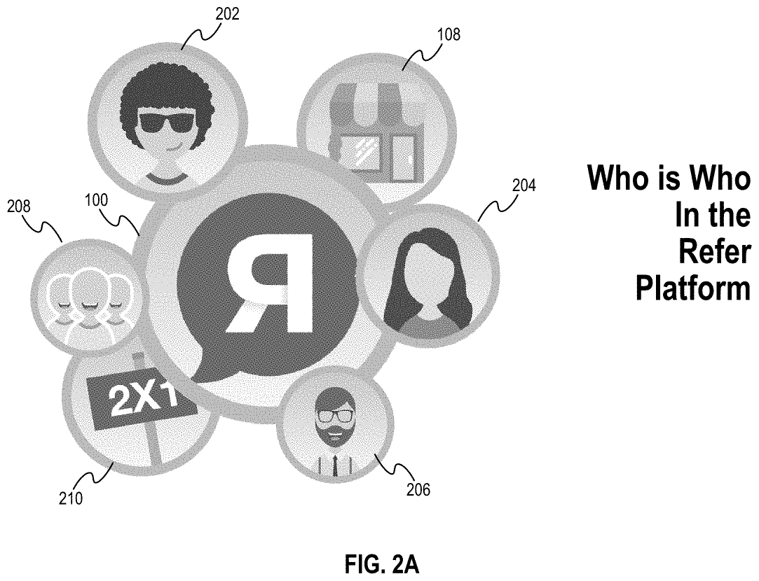

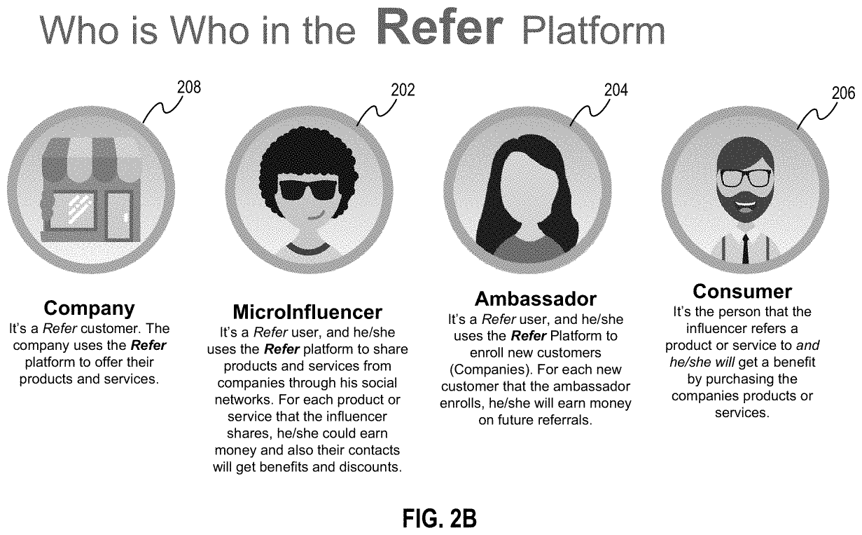

FIGS. 2A and 2B illustrate the various players that can be involved and interact with platform 100. The players include the companies 108 that create promotions 210, micro-influencers 202, Ambassadors 204, and consumers 206, and contacts 208.

Micro-influencers 202 use the platform 100 to share products and services from companies 108 through his or her social network. For each product or service the micro-influencer shares, he or she can earn money as described below. Moreover, the micro-influencer's contacts 210 can also receive benefits and discounts.

An ambassador 204 uses the platform 100 to enroll new companies 108. For each new company 108, the ambassador can earn money on future referrals related to the company 108.

The consumer 206 is the person to whom the micro-influencer refers a product or service. The consumer 206 can also get a benefit when purchasing the referred product or service.

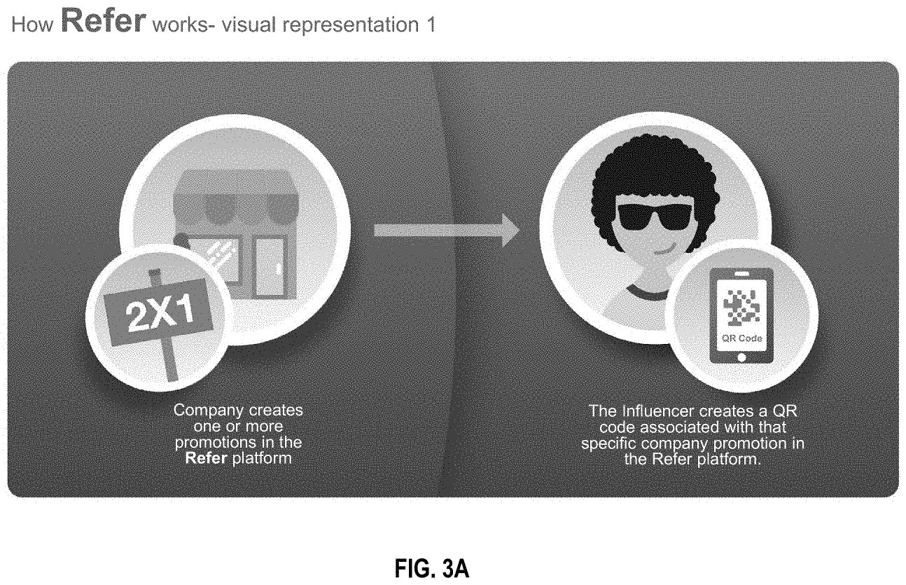

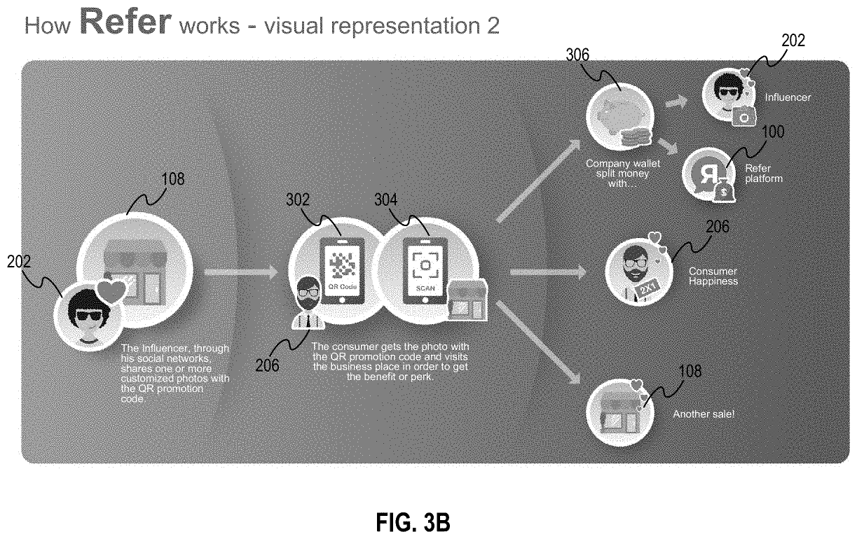

In certain embodiments, the platform 100 can use QR Codes, or some other type of code, to trace the micro-influencer's 202 and consumer's 206 actions. Ae illustrated in FIG. 3A, the company 108 creates a promotion 210 (or several) in the platform 100. The micro-influencer 202 can then create a QR Code 302 associated with company promotion 210 in the platform 100. The micro-influencer 202 shares the QR Code(s) 302, through his social networks, email, SMS, etc. It can be one or more QR Codes or customized photos with QR Codes that the micro-influencer 202 posts to their social network or shares with their contacts 210 as described in more detail below. The consumer receives QR Code 302, through social networks or other channels, or gets the photo with the QR Code 302 and visits the business 108 in order to get a benefit or perk associated with the promotion.

An employee can scan the QR Code 302, or an automatic scanner can be configured. With this action the following events are triggered: The consumer 206 gets the benefits or perks from the promotion 210; the influencer 202 gets money for each scan associated with their code 302; and the company 108 gets a new sale.

But just as importantly, the business knows in real-time, exactly where the referral came from and compensates a micro-influencer 202 only for actual referrals or business.

FIGS. 3A and 3B illustrate the above processes of how various players within platform 108 benefit in relation to various promotions 210. First as illustrated in FIG. 3A, the business 108 creates a promotion 210. The micro-influencer 202 can access a list of various promotions and create a code 302 associated with a particular promotion 210.

As illustrated in FIG. 3B, the micro-influencer 202 shares the code 302 with his contacts 208 through social media or other means. If one of those contacts 208, i.e., a consumer 206 that wants whatever the benefit of the promotion 302. The consumer 206 can then go to the business 108 to redeem the code 302. The code can be scanned, via a scanning application 304 at the business 108.

At this point, platform 100 can cause money to be transferred from the business account 306 within platform 100, or an external account, to an account 306 associated with the micro-influencer 202. The amount of compensation can be fixed for all referrals, set by the business 108 in association the promotion or ahead of time, and in some embodiments can be multiplied based on the status of the micro-influencer. In other words, more well-known influencers may have some ability to demand higher levels of compensation within the platform 100.

In certain embodiments, the platform 100 also receives payment with respect to the transaction.

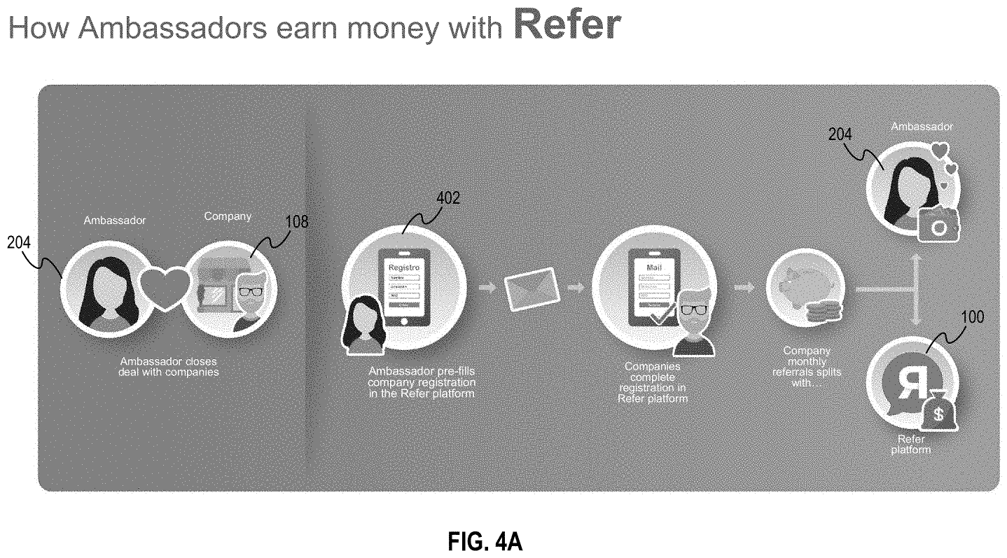

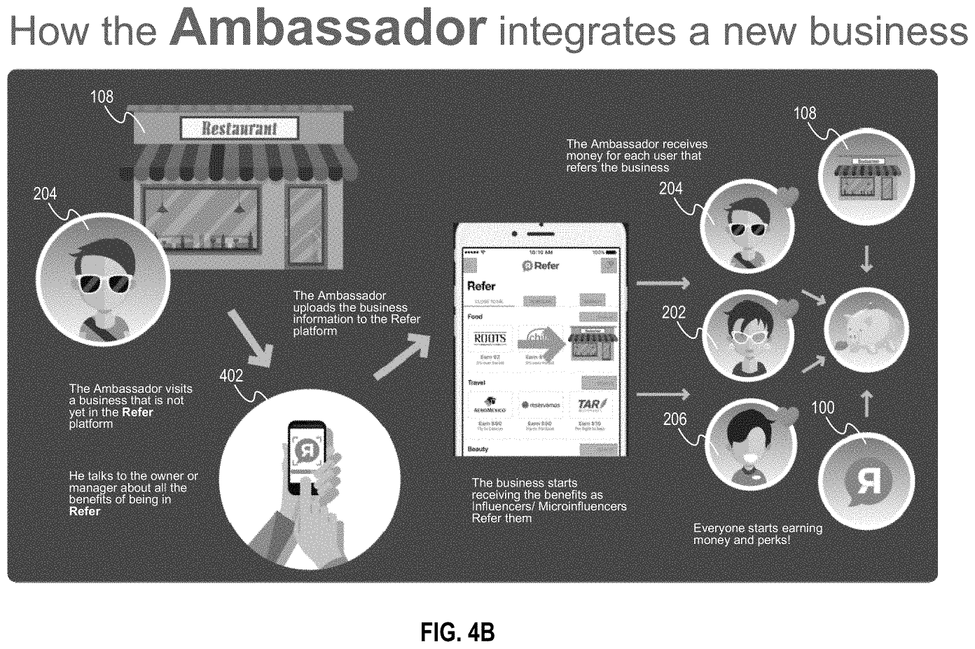

Ambassadors 204 are compensated for finding business 108 and signing them up with platform 100. FIGS. 4A and 4B are diagrams illustrating how an ambassador operates with respect to platform 100. First, as illustrated in FIG. 4A, the ambassador 204 convinces a company 108 to be part of platform 100. The ambassador 204 then generates a registration form 402 for the company 108 that the company can then complete and submit. Now the portion of the referral compensation going to platform 100 in relation to that company 108 can be shared with ambassador 204.

FIG. 4B illustrates the process in further detail. As can be seen, the ambassador 204 will typically visit company 108 and convince them to join the platform 100. The ambassador 204 can then assist the company to get the companies information loaded onto platform 100 so the company can start generating promotions. The promotions will appear to micro-influencers 202, who can know refer the promotions to contacts 208. As the referrals start generating transactions, the business shares a fee between the platform 100 and the ambassador 204: As well as the micro-influencer 202 as noted above.

In certain embodiments, platform 100 can manage “wallets” or accounts for each party on the platform, i.e., businesses 108, micro-influencers 202, ambassadors 204, as well as consumers 206. Users can charge up the account balance using a credit card or other account. In certain embodiments, the players can even transfer money or credit between accounts, e.g., a micro-influencer 202 can send money to one of the contacts 208 to use within platform 100. In certain embodiments, the platform 100 can be configured to debit and credit actual, e.g., bank accounts associated with the various platform accounts.

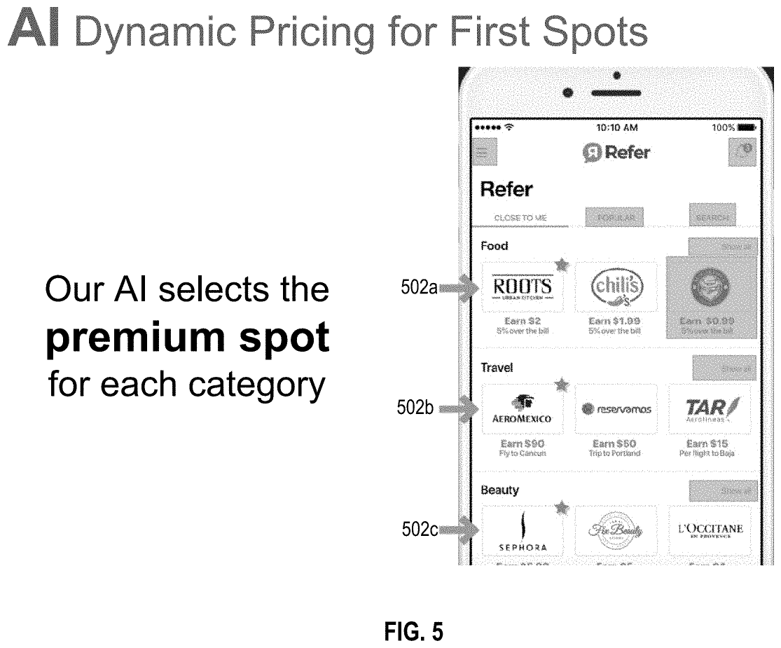

As illustrated in the screen shot of FIG. 5, businesses 108 with promotions on the platform can have the promotions listed by category 502a-c. In certain embodiments, the businesses 108 can be charged a premium price to be listed first and/or on the first page for a particular category. The can for example be done via an auction approach. The platform can also use data to determine dynamic pricing of premium positioning. For example, if the platform knows, from data received from the user's applications that there are a large number of users and/or micro-influencers in a certain area or near a certain business 108, then platform 100 can charge certain businesses 108 more for premium placing.

In addition, platform 100 can push notices and ads for certain promotions to the user's devices 110 based on their locations. Location along with other information can also be used by platform 100 to allow business 108 to manage inventory and other aspects of the business. For example, if the platform 100 determines that there is high traffic in a certain area near certain business 108 at certain times and, e.g., pushing promotions for those business results in a certain uptick in business, then this information can start be used to manage inventory, promotions, etc.

In addition, in certain embodiments, the platform 100 can manage wallets 306 for each user and business.

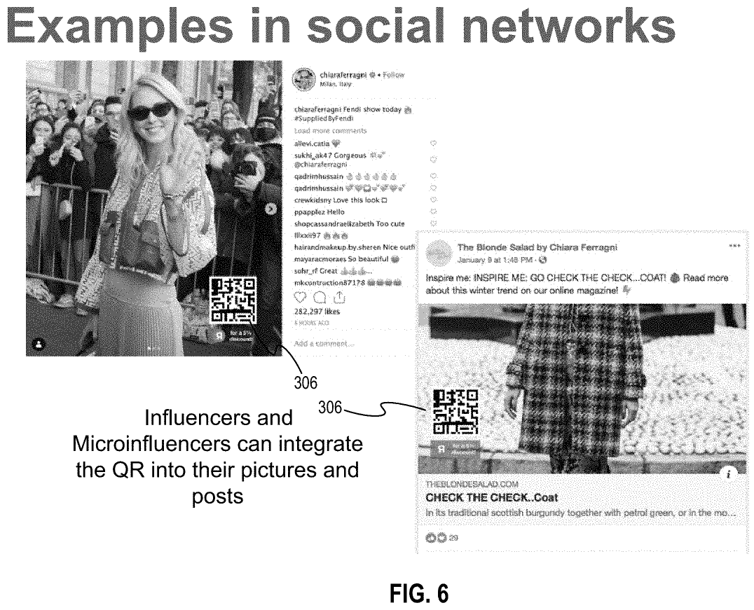

FIG. 6 is a diagram illustrating how micro-influencers can incorporate the QR codes 302 into their social media posts. In this case, the code 302 can be associated with an item they are wearing, or a location, e.g., business they are frequenting, or an event, etc. In certain embodiments, more than one code 306 can be included in a post.

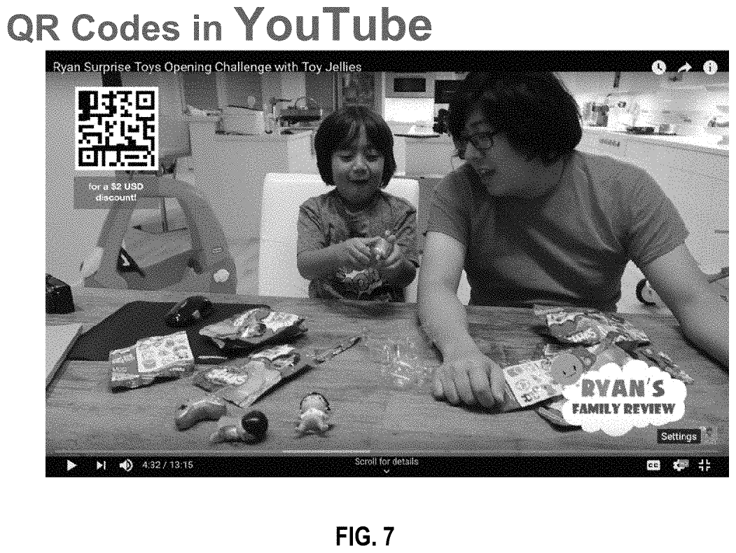

FIG. 7 illustrates how codes 302 can be included in, e.g., Youtube or other video posts. Again the code 302 can be associated with a product being shown in the video or post.

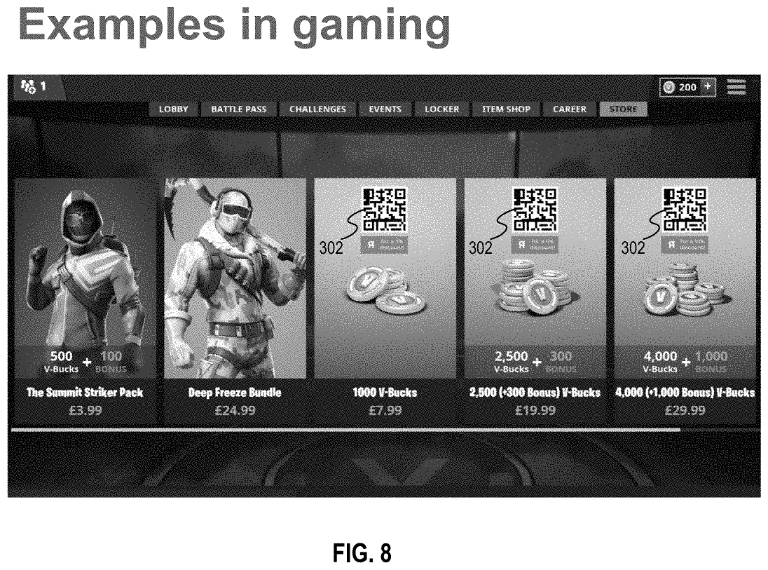

FIG. 8 illustrates an example of how the codes 302 can be used in a gaming environment. Here the code can be associated with a special offer.

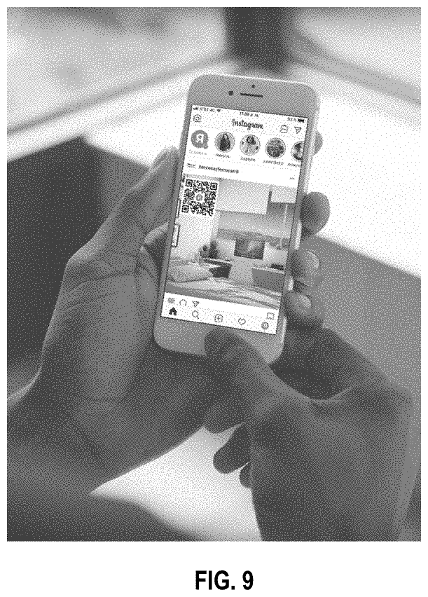

FIG. 9 illustrates how the codes can be used in, e.g, an Instagram post. Again the code 302 can be associated with a product being shown in the video or post. In general, the user can take a picture of something, and add their code that may be associated with something included in the picture, or video. In certain embodiments, the user accesses the camera through the application interface and takes a picture or video. Then the user can insert the code 302 and drag it around to position near or on the item to which the code is associated. The user can then post the image to Instagram or some other social network.

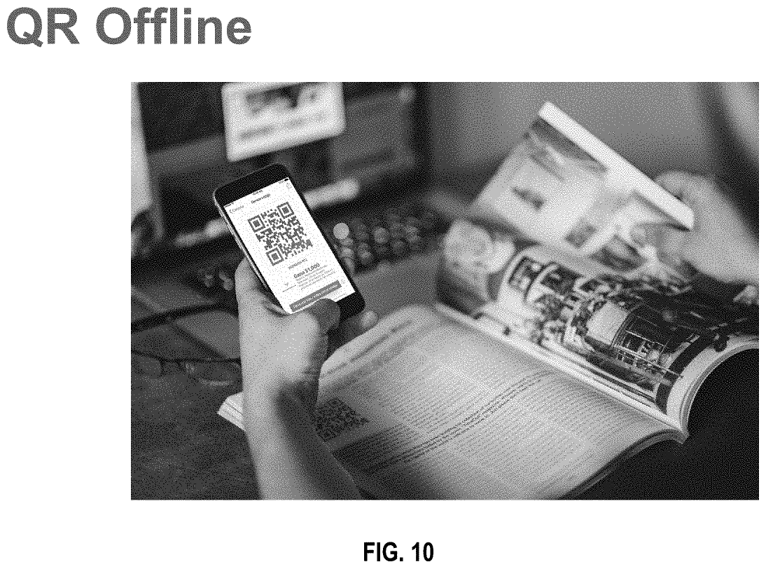

FIG. 10 is a diagram of how the codes 302 can be used offline as well. As can be seen, the code 302 can be included in print advertising. The user can then scan the codes 302 using scanner 304 within their app., which can be associated with a promotion.

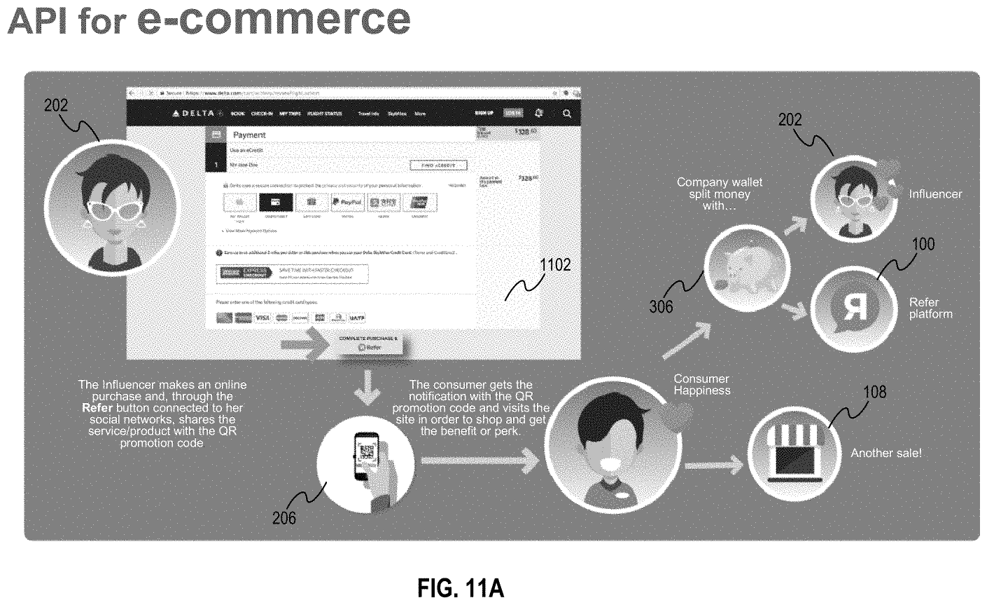

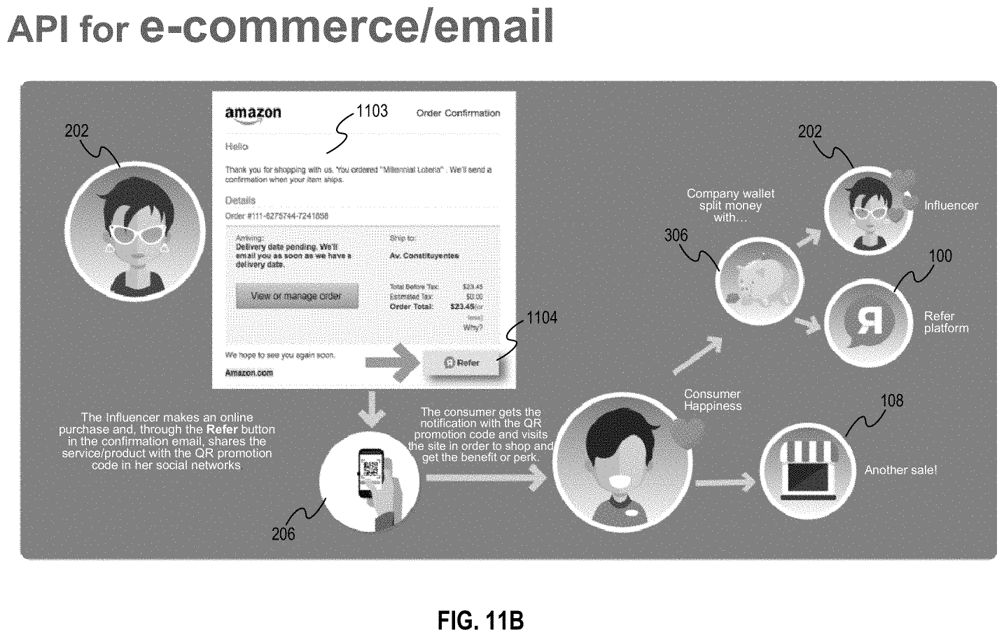

FIGS. 11A and 11B illustrate how ecommerce sites 1102 can access API's in order to also provide promotions and codes 302. In FIG. 11A, a micro-influencer 202 can make a purchase and elect to send a notification with a code 302 to the user's social media contacts. The contacts/consumers 206 will then get a notification with a code 302 that they can then use to get a benefit when they visit the site 1102.

In FIG. 11B, the site 1102 can generate an email 1103 that is sent to the micro-influencer 202 that includes a button 1104. Micro-influencer 202 can via the button 1104 forward a recommendation with a code 302 to their contacts.

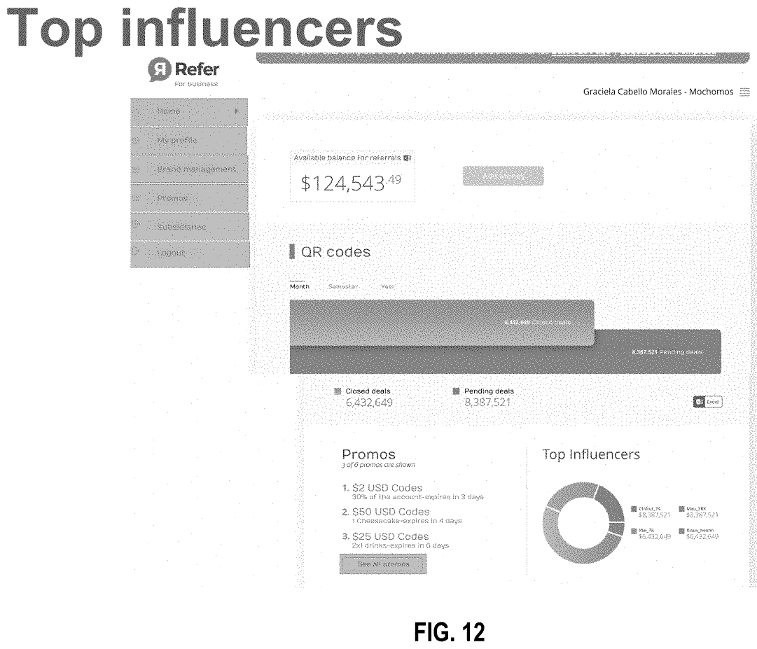

FIG. 12 is a screen shot of dashboard businesses 108 can use to see their promotions, their wallet, i.e., promotion balances, and to see who their top influencers are. Business can in certain embodiments use this information to target promotions for or to certain influencers are to provide them special benefits.

Influencers 202 and ambassadors 204 can also access their accounts and see how much is in their wallets, as well as metrics related to which promotions generate the biggest return for them. For example, and influencer can see what type of promotions, what companies, what geographic areas, which of their contacts, etc., are generating the biggest return for them. Ambassadors can, e.g., which businesses, which influencers, what type of offers, which geographical areas, etc., are generating the biggest return.

But moreover, platform 100 has this information across all businesses, influencers, and ambassadors and can use that information to make recommendations for the various users of platform 100.

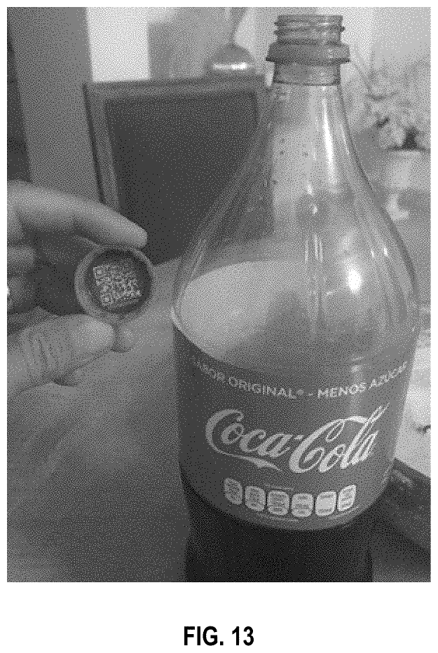

FIG. 13 is a diagram that illustrated how the codes 302 can also be used for a type of rewards program. The user can scan the code and certain reward amounts can, e.g., be deposited in their wallet 306.

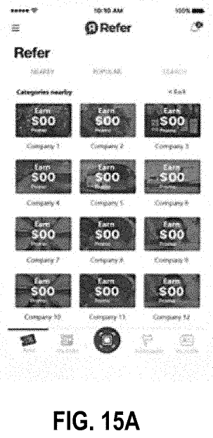

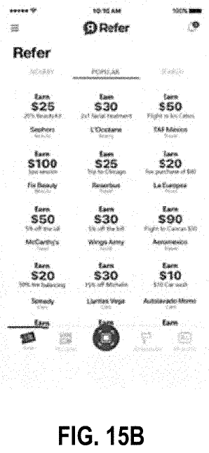

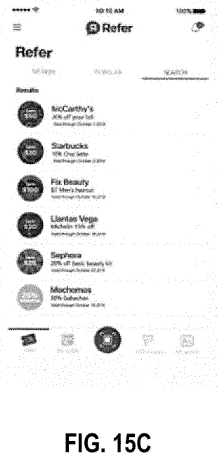

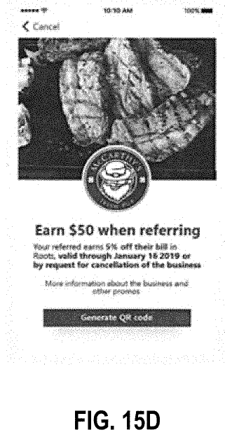

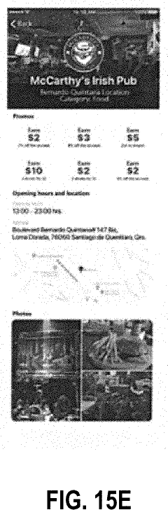

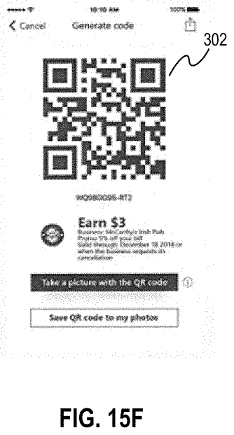

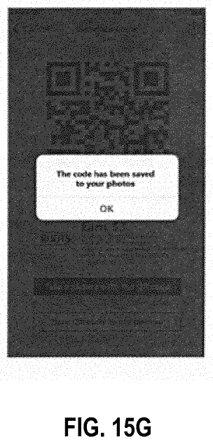

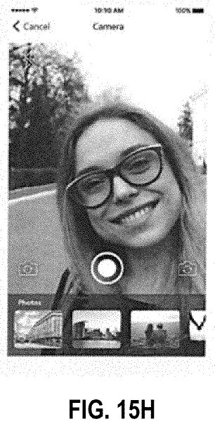

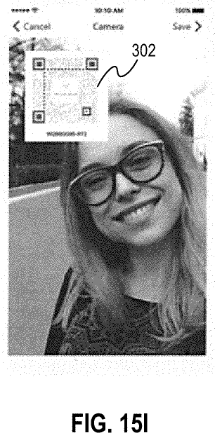

FIGS. 15A-I are screen shots that illustrate various screens that can be included in the application to log into, register, etc., with platform 100. AS illustrated in FIG. 5, when a potential influencer 202 access the application on their device, they can navigate to screens that illustrate offers that they can access. In FIG. 5 the offers are listed by category. The screen shot of FIG. 15A illustrated how the offers can be listed by “nearby”, which obviously has a geographic radius associated with the nearby filter. The screenshot of FIG. 15B illustrated how the influencer can also select and display the most popular offers. And the screen shot of FIG. 15C illustrated how an influencer 202 can search for offers based on certain criteria and how the search results can then be listed for the influencer 202.

The influencer 202 can then select the offers listed and the offer will come up. The screenshot of FIG. 15D illustrates a one-time or limited offer, while the screenshot of FIG. 15E illustrates how a business 108 can actually generate multiple different offers. As can be seen, images related to the offers as well as a map to nearby locations can also be included.

As illustrated by the screenshot of FIG. 15F if the influencer 202 selects one of the offers, then a code, such as a QR Code 302 can be generated. The code 302 will identify the business 108, possibly the ambassador 204, the specific offer, and will also be specific to the influencer 202. This way platform 100 can track the redemption and compensation for the various parties.

As can be seen, the influencer 202 can be presented with the option to save the code 302 to their photos, which will allow them to then share the code 302 with their contacts 208 or to take a picture with the QR code. If the influencer selects to save the code 302, then it will be saved and a confirmation can be presented as in the screen shot of FIG. 15G.

If the user selects to take a photo, then as illustrated in the screenshot of FIG. 15G, the user can take a photo, or select a photo, and then insert the code 302 and save the picture with the code 302. The user can then share the picture, and therefore the code 302 with the contacts.

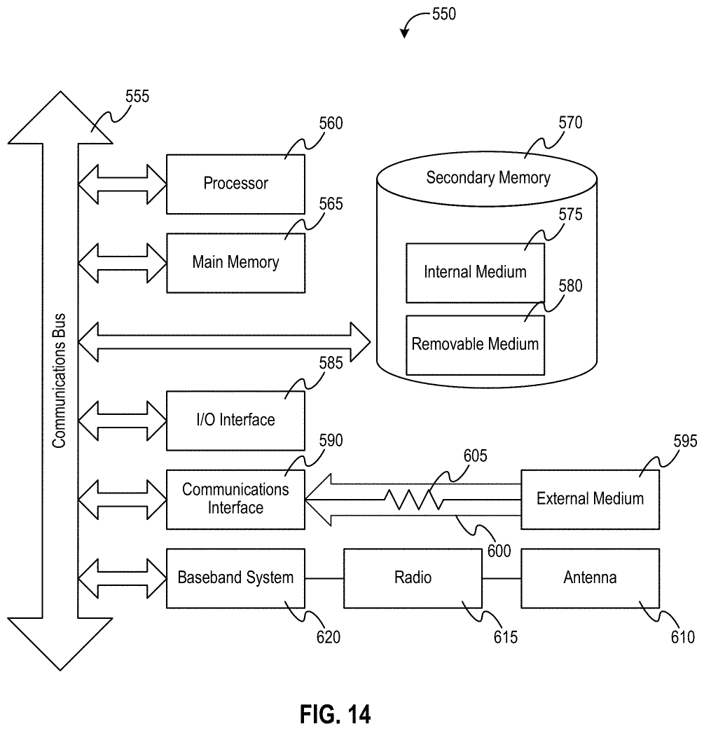

FIG. 14 is a block diagram illustrating an example wired or wireless system 550 that can be used in connection with various embodiments described herein. For example the system 550 can be used as or in conjunction with one or more of the platforms, devices or processes described above, and may represent components of device, the corresponding backend server(s), and/or other devices described herein. The system 550 can be a server or any conventional personal computer, or any other processor-enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560. Examples of processors which may be used with system 550 include, without limitation, the Pentium® processor, Core i7® processor, and Xeon® processor, all of which are available from Intel Corporation of Santa Clara, Calif.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

System 550 preferably includes a main memory 565 and may also include a secondary memory 570. The main memory 565 provides storage of instructions and data for programs executing on the processor 560, such as one or more of the functions and/or modules discussed above. It should be understood that programs stored in the memory and executed by processor 560 may be written and/or compiled according to any suitable language, including without limitation C/C++, Java, JavaScript, Pearl, Visual Basic, .NET, and the like. The main memory 565 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

The secondary memory 570 may optionally include an internal memory 575 and/or a removable medium 580, for example a floppy disk drive, a magnetic tape drive, a compact disc (CD) drive, a digital versatile disc (DVD) drive, other optical drive, a flash memory drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer-readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 590. Examples of external storage medium 595 may include an external hard disk drive or an external optical drive, or and external magneto-optical drive.

Other examples of secondary memory 570 may include semiconductor-based memory such as programmable read-only memory (PROM), erasable programmable read-only memory (EPROM), electrically erasable read-only memory (EEPROM), or flash memory (block oriented memory similar to EEPROM). Also included are any other removable storage media 580 and communication interface 590, which allow software and data to be transferred from an external medium 595 to the system 550.

System 550 may include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 550 with a network or another computing device.

Communication interface 590 preferably implements industry promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

In an embodiment, I/O interface 585 provides an interface between one or more components of system 550 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and the like.

The system 550 also includes optional wireless communication components that facilitate wireless communication over a voice and over a data network. The wireless communication components comprise an antenna system 610, a radio system 615 and a baseband system 620. In the system 550, radio frequency (RF) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown).

Various embodiments may also be implemented primarily in hardware using, for example, components such as application specific integrated circuits (ASICs), or field programmable gate arrays (FPGAs). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, functions, and methods described in connection with the embodiments disclosed herein can be implemented or performed with a general purpose processor, a digital signal processor (DSP), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

Any of the software components described herein may take a variety of forms. For example, a component may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, as a web-enabled software application, and/or as a mobile application.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed:

1. A referral platform, comprising:
one or more storage devices;
one or more servers configured to host the referral platform, the servers configured to:
allow a plurality of businesses to access the platform, register, and create promotions associated with a benefit related to a particular business of the plurality of businesses and an amount the business will share for a referral related to the promotion;
allow users to access the platform, select a promotion, create a personalized code that includes information identifying the associated business, information defining a benefit associated with the promotion, and that identifies the user, and share the personalized code with at least one contact, wherein the at least one contact can use the personalized code to obtain the benefit.

2. The platform of claim 1, wherein the one or more servers are further configured to track when the at least one contact used the personalized code to obtain the benefit and pay the amount to the user associated with the personalized code.

3. The platform of FIG. 2, wherein the one or more servers are configured to credit a wallet managed by the platform and associated with the user associated with the personalized code with the amount.

4. The platform of claim 2, wherein the one or more servers are configured to track when the at least one contact used the personalized code to obtain the benefit by detecting when the personalized code is scanned at the business associated with the promotion.

5. The platform of claim 1, wherein the user associated with the personalized code can share the personalized code via an application used by users to access the platform.

6. The platform of claim 1, wherein the user associated with the personalized code can share the personalized code via email, text massage, or a social media post.
